(19) United States
(12) Patent Application Publication
(10) Pub. No.: US 2024/0317969 A1
(43) Pub. Date: Sep. 26, 2024

(54) RUBBER COMPOSITION FOR PNEUMATIC TIRES AND PNEUMATIC TIRE

(71) Applicant: Toyo Tire Corporation, Itami-shi (JP)

(72) Inventors: Hama Nagai, Itami-shi (JP); Norio Minouchi, Itami-shi (JP)

(73) Assignee: Toyo Tire Corporation, Itami-shi (JP)

(21) Appl. No.: 18/442,507

(22) Filed: Feb. 15, 2024

(30) Foreign Application Priority Data
Mar. 22, 2023 (JP) 2023-044849

(51) Int. Cl. C08K 5/375; C08K 5/098

(52) U.S. Cl. CPC C08K 5/375; C08K 5/098

(57) ABSTRACT

A rubber composition for pneumatic tires, containing a diene-based rubber, a fatty acid metal salt, and a compound represented by following Formula (1):

[Formula 1]

R—S—(CH₂)ₓ—S—R (1)

(wherein x is an integer of 2 to 12 and R contains a sulfur atom and contains a thiocarbamoyl group having an aromatic hydrocarbon or an aliphatic hydrocarbon, a benzothiazole group having an aromatic hydrocarbon or an aliphatic hydrocarbon, or a —SO₃⁻Na⁺ group), wherein when a total amount of a diene-based rubber is taken as 100 parts by mass, the fatty acid metal salt is contained in an amount of 3 to 30 parts by mass and the compound represented by Formula (1) is contained in an amount of 0.15 to 1.5 parts by mass, and when a total amount of a diene-based rubber is taken as 100 parts by mass, a content of a metal oxide is less than 0.5 parts by mass.

### BACKGROUND OF THE INVENTION

### Field of the Invention

The present invention relates to a rubber composition for pneumatic tires and a pneumatic tire.

### Description of the Related Art

In recent years, attention has been focused on that metal oxides such as zinc oxide and metallic elements have reproductive toxicity and toxicity to aquatic life, and therefore there has been a demand for a rubber composition for pneumatic tires which contains a lower amount of a metal oxide such as zinc oxide.

Patent Document 1 mentioned below describes a rubber composition for tire treads which contains 100 parts by weight of at least one of a diene-based rubber, butyl rubber, and a halogenated butyl rubber, 20 to 100 parts by weight of silica, 3 to 80 parts by weight of carbon black, 0.5 to 12 parts by weight of a silane coupling agent containing a sulfur atom in its molecule, and 0.5 to 5 parts by weight of zinc stearate.

Patent Document 2 mentioned below describes a sulfur-crosslinkable rubber composition containing 2 parts by mass or less of zinc oxide, especially 10 parts by mass or less of a higher fatty acid zinc salt per 100 parts by mass of a rubber.

Patent Document 3 mentioned below describes a rubber composition for base treads which contains carbon black having a nitrogen adsorption specific surface area of 10 to 80 m²/g and contains, per 100 parts by mass of a rubber component, 0.2 to 5 parts by mass of a specific compound having a zinc atom at the center of its structure and 1.0 parts by mass or less of zinc oxide.

### PRIOR ART DOCUMENTS

### Patent Documents

Patent Document 1: JP-A-2001-26672
Patent Document 2: JP-A-2012-92263
Patent Document 3: JP-B2-5437951

### SUMMARY OF THE INVENTION

However, as a result of an intensive study, the present inventor has found that the rubber properties and fatigue resistance of vulcanized rubbers obtained using, as raw materials, the rubber compositions obtained by the techniques described in the above patent documents tend to deteriorate, and therefore these rubber compositions have room for improvement particularly when used as raw materials of pneumatic tires.

In light of the above circumstances, it is an object of the present invention to provide a rubber composition for pneumatic tires which is capable of maintaining and improving rubber properties after vulcanization while reducing its metal oxide content.

The above object can be achieved by the present invention as described below. Specifically, the present invention relates to a rubber composition for pneumatic tires (1), containing a diene-based rubber, a fatty acid metal salt, and a compound represented by following Formula (1):

[Formula 1]

R—S—(CH₂)ₓ—S—R (1)

(wherein x is an integer of 2 to 12 and R contains a sulfur atom and contains a thiocarbamoyl group having an aromatic hydrocarbon or an aliphatic hydrocarbon, a benzothiazole group having an aromatic hydrocarbon or an aliphatic hydrocarbon, or a —SO₃⁻Na⁺ group), wherein when a total amount of a diene-based rubber is taken as 100 parts by mass, the fatty acid metal salt is contained in an amount of 3 to 30 parts by mass and the compound represented by Formula (1) is contained in an amount of 0.15 to 1.5 parts by mass, and when a total amount of a diene-based rubber is taken as 100 parts by mass, a content of a metal oxide is less than 0.5 parts by mass.

The rubber composition for pneumatic tires (1) is preferably the rubber composition for pneumatic tires (2) in which the fatty acid metal salt is at least one selected from the group consisting of zinc stearate and zinc laurate.

The rubber composition for pneumatic tires (1) is preferably the rubber composition for pneumatic tires (3) in which the fatty acid metal salt is zinc stearate.

The rubber composition for pneumatic tires (1) is preferably the rubber composition for pneumatic tires (4) in which the compound represented by Formula (1) is at least one selected from the group consisting of 1,6-bis(N,N′-dibenzylthiocarbamoyldithio)hexane and 1,6-hexamethylene-sodium dithiosulfate dihydrate.

The rubber composition for pneumatic tires (1) is preferably the rubber composition for pneumatic tires (5) in which the compound represented by Formula (1) is 1,6-bis(N,N′-dibenzylthiocarbamoyldithio)hexane.

The rubber composition for pneumatic tires (1) is preferably the rubber composition for pneumatic tires (6) in which the fatty acid metal salt is at least one selected from the group consisting of zinc stearate and zinc laurate, and
the compound represented by Formula (1) is at least one selected from the group consisting of 1,6-bis(N,N′-dibenzylthiocarbamoyldithio)hexane and 1,6-hexamethylene-sodium dithiosulfate dihydrate.

The rubber composition for pneumatic tires (1) is preferably the rubber composition for pneumatic tires (7) in which the fatty acid metal salt is zinc stearate and the compound represented by Formula (1) is 1,6-bis(N,N′-dibenzylthiocarbamoyldithio)hexane.

The rubber composition for pneumatic tires (1) is preferably the rubber composition for pneumatic tires (8) which further contains 1 to 3 parts by mass of sulfur in terms of sulfur content.

The rubber composition for pneumatic tires (6) is preferably the rubber composition for pneumatic tires (9) which further contains 1 to 3 parts by mass of sulfur in terms of sulfur content.

The rubber composition for pneumatic tires (7) is preferably the rubber composition for pneumatic tires (10) which further contains 1 to 3 parts by mass of sulfur in terms of sulfur content.

The present invention also relates to a pneumatic tire comprising at least a vulcanized rubber of the rubber composition for pneumatic tires (1).

The present invention also relates to a pneumatic tire comprising at least a vulcanized rubber of the rubber composition for pneumatic tires (6).

The present invention also relates to a pneumatic tire comprising at least a vulcanized rubber of the rubber composition for pneumatic tires (7).

The present invention also relates to a pneumatic tire comprising at least a vulcanized rubber of the rubber composition for pneumatic tires (8).

The present invention also relates to a pneumatic tire comprising at least a vulcanized rubber of the rubber composition for pneumatic tires (9).

The present invention also relates to a pneumatic tire comprising at least a vulcanized rubber of the rubber composition for pneumatic tires (10).

The rubber composition for pneumatic tires according to the present invention contains a fatty acid metal salt and a compound represented by Formula (1) in specific amounts, and therefore the rubber properties of a vulcanized rubber of the rubber composition can be maintained and improved even when the content of a metal oxide is set to less than 0.5 parts by mass. It should be noted that as shown by results described later, the rubber properties of a vulcanized rubber deteriorate when a rubber composition in which only the fatty acid metal salt is contained in a specific amount or a rubber composition in which only the compound represented by Formula (1) is contained in a specific amount is used. The rubber composition for pneumatic tires according to the present invention exerts its effect by using the fatty acid metal salt and the compound represented by Formula (1) in combination.

### DETAILED DESCRIPTION OF THE PREFERRED EMBODIMENTS

In consideration of environmental problems, a rubber composition for pneumatic tires according to the present invention contains a metal oxide such as zinc oxide in an amount of less than 0.5 parts by mass when the total amount of a diene-based rubber is taken as 100 parts by mass. The rubber composition for pneumatic tires according to the present invention preferably contains less than 0.3 parts by mass of a metal oxide such as zinc oxide when the total amount of a diene-based rubber is taken as 100 parts by mass, and more preferably contains no metal oxide such as zinc oxide.

The rubber composition for pneumatic tires according to the present invention contains a diene-based rubber. Examples of the diene-based rubber include styrene butadiene rubbers such as emulsion-polymerized polystyrene butadiene rubber (hereinafter also referred to as “E-SBR”) obtained by emulsion polymerization in water and solution-polymerized polystyrene butadiene rubber (hereinafter also referred to as “S-SBR”), natural rubber, isoprene rubber, and butadiene rubber.

The rubber composition for pneumatic tires according to the present invention contains a fatty acid metal salt. The fatty acid metal salt is preferably a zinc salt constituted from two fatty acids that are the same or different and have 20 or less carbon atoms, and examples of such a zinc salt include zinc stearate (number of carbon atoms: 18), zinc laurate (number of carbon atoms: 12), and zinc 2-ethylhexanoate (number of carbon atoms: 8 (branched)). Among these, zinc stearate or zinc laurate is preferred. The amount of the fatty acid metal salt contained in the rubber composition for pneumatic tires is preferably 3 to 30 parts by mass, more preferably 3 to 25 parts by mass when the total amount of the diene-based rubber is taken as 100 parts by mass.

The rubber composition for pneumatic tires according to the present invention contains a compound represented by following Formula (1):

[Formula 2]

R—S—(CH₂)ₓ—S—R (1)

(wherein x is an integer of 2 to 12 and R contains a sulfur atom and contains a thiocarbamoyl group having an aromatic hydrocarbon or an aliphatic hydrocarbon, a benzothiazole group having an aromatic hydrocarbon or an aliphatic hydrocarbon, or a —SO₃⁻Na⁺ group). Among the compounds represented by Formula (1), preferred is 1,6-bis(N,N′-dibenzylthiocarbamoyldithio)hexane represented by following Formula (1a):

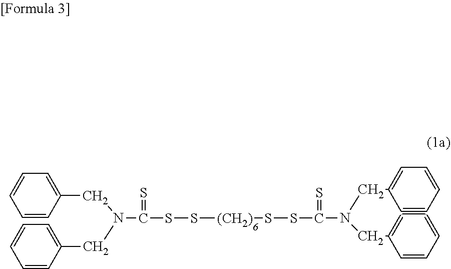

or hexamethylene-1,6-bis(sodium thiosulfate)hydrate represented by following Formula (1b):

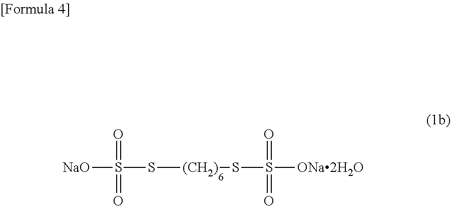

The amount of the compound represented by Formula (1) contained in the rubber composition for pneumatic tires is preferably 0.15 to 1.5 parts by mass, more preferably 0.15 to 1.0 parts by mass when the total amount of the diene-based rubber is taken as 100 parts by mass.

The rubber composition for pneumatic tires according to the present invention is characterized in that the fatty acid metal salt and the compound represented by Formula (1) are used in combination, but from the viewpoint of further improving rubber properties and fatigue resistance after vulcanization, the ratio between a content X of the fatty acid metal salt and a content Y of the compound represented by Formula (1) in the rubber composition for pneumatic tires preferably satisfies 2≤X/Y≤70.

The rubber composition for pneumatic tires according to the present invention may contain carbon black as a filler. Examples of the carbon black that can be used include: carbon blacks usually used in the rubber industry, such as SAF, ISAF, HAF, FEF, and GPF; and conductive carbon blacks such as acetylene black and ketjen black. The amount of the carbon black contained in the rubber composition for pneumatic tires according to the present invention is preferably 1 to 80 parts by mass, more preferably 3 to 60 parts by mass when the total amount of the diene-based rubber is taken as 100 parts by mass.

Further, silica is also preferably contained as a filler. Examples of the silica to be used include silicas usually used for rubber reinforcement, such as wet silica, dry silica, sol-gel silica, and surface-treated silica. Among these, wet silica is preferred. The amount of the silica contained in the rubber composition for pneumatic tires according to the present invention is preferably 20 to 150 parts by mass, more preferably 30 to 100 parts by mass when the total amount of the diene-based rubber is taken as 100 parts by mass.

When silica is contained as a filler, a silane coupling agent is also preferably contained together. The silane coupling agent is not limited as long as sulfur is contained in the molecule thereof, and various silane coupling agents to be added to rubber compositions together with silica may be used. Examples of such silane coupling agents include: sulfidesilanes such as bis(3-triethoxysilylpropyl)tetrasulfide (e.g., “Si69” manufactured by Degussa), bis(3-triethoxysilylpropyl)disulfide (e.g., “Si75” manufactured by Degussa), bis(2-triethoxysilylethyl)tetrasulfide, bis(4-triethoxysilylbutyl)disulfide, bis(3-trimethoxysilylpropyl)tetrasulfide, and bis(2-trimethoxysilylethyl)disulfide; mercaptosilanes such as γ-mercaptopropyltrimethoxysilane, γ-mercaptopropyltriethoxysilane, mercaptopropylmethyldimethoxysilane, mercaptopropyldimethylmethoxysilane, and mercaptoethyltriethoxysilane; and protected mercaptosilanes such as 3-octanoylthio-1-propyltriethoxysilane and 3-propionylthiopropyltrimethoxysilane. The content of the silane coupling agent is preferably 1 to 20 parts by mass, more preferably 1 to 15 parts by mass per 100 parts by mass of the silica.

The rubber composition for pneumatic tires according to the present invention may further contain, in addition to the diene-based rubber, the fatty acid metal salt, the compound represented by Formula (1), the carbon black, the silica, and the silane coupling agent, a vulcanization-type compounding agent, an antiaging agent, stearic acid, a softener such as wax or oil, a processing aid, etc.

Examples of the antiaging agent include antiaging agents usually used for rubber, such as an aromatic amine-based antiaging agent, an amine-ketone-based antiaging agent, a monophenol-based antiaging agent, a bisphenol-based antiaging agent, a polyphenol-based antiaging agent, a dithiocarbamic acid salt-based antiaging agent, and a thiourea-based antiaging agent, and these may be used singly or in an appropriate combination of two or more of them. The content of the antiaging agent is preferably 0.5 to 10 parts by mass when the total amount of the diene-based rubber is taken as 100 parts by mass.

Examples of the vulcanization-type compounding agent include a vulcanizing agent such as sulfur or an organic peroxide, a vulcanization accelerator, a vulcanization accelerator aid, and a vulcanization retarder.

The sulfur as the vulcanization-type compounding agent is not limited as long as it is sulfur usually used for rubber, and examples of such sulfur that can be used include powdered sulfur, precipitated sulfur, insoluble sulfur, and highly-dispersible sulfur. When rubber properties and durability after vulcanization are taken into consideration, the content of the sulfur is preferably 0.1 to 10 parts by mass, more preferably 1 to 3 parts by mass in terms of sulfur content when the total amount of the diene-based rubber is taken as 100 parts by mass.

Examples of the vulcanization accelerator include vulcanization accelerators usually used for rubber vulcanization, such as a sulfenamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamic acid salt-based vulcanization accelerator, and these may be used singly or in an appropriate combination of two or more of them. The content of the vulcanization accelerator is preferably 0.1 to 10 parts by mass when the total amount of the diene-based rubber is taken as 100 parts by mass.

The rubber composition for pneumatic tires according to the present invention is obtained by kneading, in addition to the diene-based rubber, the fatty acid metal salt, the compound represented by Formula (1), the carbon black, the silica, and the silane coupling agent, the vulcanization-type compounding agent, the antiaging agent, stearic acid, the softener such as wax or oil, the processing aid, etc. with the use of a kneading machine usually used in the rubber industry, such as a Banbury mixer, a kneader, or a roll.

A method for blending the above components is not limited, and any one of the following methods may be used: a method in which components to be blended other than vulcanization-type compounding agents such as a sulfur-based vulcanizing agent and a vulcanization accelerator are previously kneaded to prepare a master batch, the remaining component is added to the master batch, and the mixture is further kneaded, a method in which components are added in any order and kneaded, and a method in which all the components are added at the same time and kneaded.

The rubber composition for pneumatic tires according to the present invention can maintain and improve rubber properties after vulcanization while reducing its metal oxide content. Therefore, the rubber composition for pneumatic tires according to the present invention is particularly useful for pneumatic tires, especially for tread members of pneumatic tires.

### EXAMPLES

Hereinbelow, the configuration and effect of the present invention will be described with reference to specific examples etc. It should be noted that in examples etc., evaluations of evaluation items were performed based on the following evaluation criteria on rubber samples obtained by heating and vulcanizing rubber compositions at 160° C. for 30 minutes.

### (Vulcanized Rubber Hardness (23° C.))

The hardness was measured using a type A durometer at a temperature of 23° C. in accordance with JIS K6253. In Table 1, the vulcanized rubber hardness of Reference Example 2 is indicated as an index number when the vulcanized rubber hardness of Reference Example 1 is taken as 100. In Table 2, the vulcanized rubber hardness of each of Comparative Example 2 and Example 1 is indicated as an index number when the vulcanized rubber hardness of Comparative Example 1 is taken as 100. In Table 3, the vulcanized rubber hardness of each of Comparative Examples 4 and 5 and Examples 2 to 6 is indicated as an index number when the vulcanized rubber hardness of Comparative Example 3 is taken as 100. In Table 4, the vulcanized rubber hardness of Example 7 is indicated as an index number when the vulcanized rubber hardness of Comparative Example 6 is taken as 100. In all of the cases, a larger index number indicates that the rubber hardness of the vulcanized rubber is higher at ordinary temperature.

### (Vulcanized Rubber Tear Strength)

A crescent test piece specified in JIS K6252 was punched out and a nick of 0.50±0.08 mm was made at the center of a depression to obtain a sample. The vulcanized rubber tear strength was measured by subjecting the sample to a test using a tensile tester manufactured by SHIMADZU CORPORATION at a tensile speed of 500 mm/min. In Table 1, the tear strength of Reference Example 2 is indicated as an index number when the tear strength of Reference Example 1 is taken as 100. In Table 2, the tear strength of each of Comparative Example 2 and Example 1 is indicated as an index number when the tear strength of Comparative Example 1 is taken as 100. In Table 3, the tear strength of each of Comparative Examples 4 and 5 and Examples 2 to 6 is indicated as an index number when the tear strength of Comparative Example 3 is taken as 100. In Table 4, the tear strength of Example 7 is indicated as an index number when the tear strength of Comparative Example 6 is taken as 100. In all of the cases, a larger index number indicates that the vulcanized rubber is more excellent in tear strength.

### (Vulcanized Rubber Fatigue Resistance)

The fatigue resistance was evaluated by measuring the time before a crack of 10 mm was produced in a test piece in accordance with a flex cracking test specified in JIS K6260. In Table 1, the fatigue resistance of Reference Example 2 is indicated as an index number when the fatigue resistance of Reference Example 1 is taken as 100. In Table 2, the fatigue resistance of each of Comparative Example 2 and Example 1 is indicated as an index number when the fatigue resistance of Comparative Example 1 is taken as 100. In Table 3, the fatigue resistance of each of Comparative Examples 4 and 5 and Examples 2 to 6 is indicated as an index number when the fatigue resistance of Comparative Example 3 is taken as 100. In Table 4, the fatigue resistance of Example 7 is indicated as an index number when the fatigue resistance of Comparative Example 6 is taken as 100. In all of the cases, a larger index number means that the vulcanized rubber is more excellent in fatigue resistance.

### (Preparation of Rubber Compositions)

Rubber compositions of Reference Examples 1 and 2, Examples 1 to 7, and Comparative Examples 1 to 6 were prepared according to formulations shown in Tables 1 to 4 by kneading using a usual Banbury mixer. Compounding agents listed in Tables 1 to 4 are shown below (in Tables 1 to 4, the amount of each of the compounding agents added is expressed in parts by mass per 100 parts by mass of the rubber component). It should be noted that E-SBR used in Tables 2 and 3 is a 37.5 phr oil extended product, and therefore an actual amount of rubber excluding oil is shown in parenthesis.
E-SBR; “SBR1723” (styrene content: 23.5 mass %, 37.5 phr oil extended) manufactured by ENEOS Materials Corporation
S-SBR; “HPR350” (styrene content: 20.5 mass %) manufactured by ENEOS Materials Corporation
BR; “BR150B” manufactured by UBE Elastomer Co., Ltd.
NR; “RSS #3”
Carbon black (1); “SEAST 3” manufactured by Tokai Carbon Co., Ltd.
Carbon black (2); “SEAST 6” manufactured by Tokai Carbon Co., Ltd.
Silica; “Ultrasil VN3” manufactured by Evonik Industries AG
Silane coupling agent; bis(3-triethoxysilylpropyl)tetrasulfide, “Si69” manufactured by Evonik Industries AG
Oil; “Process NC-140”, manufactured by JXTG Energy Corporation
Zinc oxide: “Zinc Oxide Grade 2” (manufactured by MITSUI MINING & SMELTING CO., LTD.)
Stearic acid: “LUNAC S-20” manufactured by Kao Corporation
Fatty acid metal salt (1); zinc stearate, “Zn-St” manufactured by Nitto Kasei Co., Ltd.
Fatty acid metal salt (2); zinc laurate, “ZS-3” manufactured by Nitto Kasei Co., Ltd.
Antiaging agent; “Antigen 6C”, manufactured by SUMITOMO CHEMICAL COMPANY, LIMITED
Sulfur: “5% OIL TREATED POWDER SULFUR” (manufactured by Tsurumi Chemical Industry Co., ltd.)
Vulcanization accelerator (1); “NOCCELER CZ-G (CZ)” manufactured by OUCHI SHINKO CHEMICAL INDUSTRIAL CO., LTD.
Vulcanization accelerator (2): “NOCCELER D” manufactured by OUCHI SHINKO CHEMICAL INDUSTRIAL CO., LTD.
Compound (1) represented by Formula (1); 1,6-bis(N,N′-dibenzylthiocarbamoyldithio)hexane, “KA9188” manufactured by LANXESS
Compound (2) represented by Formula (1); 1,6-hexamethylene-sodium dithiosulfate dihydrate, “Duralink-HTS” manufactured by Eeastman Chemical Company

TABLE 1

| | Reference | Reference |
|---|---|---|
| | Example 1 | Example 2 |
| E-SBR | — | — |
| S-SBR | 100 | 100 |
| BR | — | — |
| NR | — | — |
| Carbon black (1) | 5 | 5 |
| Carbon black (2) | — | — |
| Silica | 80 | 80 |
| Silane coupling agent | 8 | 8 |
| Oil | 5 | 5 |
| Zinc oxide | 2 | — |
| Stearic acid | 2 | — |
| Fatty acid metal salt (1) | — | 4 |
| Fatty acid metal salt (2) | — | — |
| Antiaging agent | 2 | 2 |
| Sulfur | 2 | 2 |
| Vulcanization accelerator (1) | 1.5 | 1.5 |
| Vulcanization accelerator (2) | 0.5 | 0.5 |
| Compound (1) represented by | — | — |
| Formula (1) | | |
| Compound (2) represented by | — | — |
| Formula (1) | | |
| Vulcanized rubber hardness | 100 | 101 |
| (23° C.) (INDEX) | | |
| Vulcanized rubber tear strength | 100 | 79 |
| (INDEX) | | |
| Vulcanized rubber fatigue | 100 | 24 |
| resistance (INDEX) | | |

As can be seen from the results shown in Table 1, when a fatty acid metal salt is added instead of zinc oxide and stearic acid (Reference Example 2), the rubber properties, especially the tear strength and fatigue resistance of the vulcanized rubber significantly deteriorate as compared to Reference Example 1 in which zinc oxide and stearic acid are added.

TABLE 2

| | Comparative | Comparative | Example |
|---|---|---|---|
| | Example 1 | Example 2 | 1 |
| E-SBR | 55 (40) | 55 (40) | 55 (40) |
| S-SBR | 60 | 60 | 60 |
| BR | — | — | — |
| NR | — | — | — |
| Carbon black (1) | 40 | 40 | 40 |
| Carbon black (2) | — | — | — |
| Silica | 40 | 40 | 40 |
| Silane coupling agent | 4 | 4 | 4 |
| Oil | 5 | 5 | 5 |
| Zinc oxide | 2 | — | — |
| Stearic acid | 2 | — | — |
| Fatty acid metal salt (1) | — | 4 | 3 |
| Fatty acid metal salt (2) | — | — | — |
| Antiaging agent | 2 | 2 | 2 |
| Sulfur | 2 | 2 | 1.4 |
| Vulcanization accelerator (1) | 1.5 | 1.5 | 1.5 |
| Vulcanization accelerator (2) | 0.5 | 0.5 | 0.5 |
| Compound (1) represented | — | — | 0.15 |
| by Formula (1) | | | |
| Compound (2) represented | — | — | — |
| by Formula (1) | | | |
| Vulcanized rubber hardness | 100 | 100 | 100 |
| (23° C.) (INDEX) | | | |
| Vulcanized rubber tear | 100 | 75 | 103 |
| strength (INDEX) | | | |
| Vulcanized rubber fatigue | 100 | 30 | 105 |
| resistance (INDEX) | | | |

As can be seen from the results shown in Table 2, the vulcanized rubber of the rubber composition of Example 1 can maintain and improve the rubber properties while maintaining the rubber hardness without using zinc oxide. On the other hand, it can be seen that in the case of Comparative Example 2 obtained by adding only the fatty acid metal salt without adding the compound represented by Formula (1), the rubber properties, especially the tear strength and fatigue resistance of the vulcanized rubber significantly deteriorate.

TABLE 3

| | Com- | Com- | | |
|---|---|---|---|---|
| | parative | parative | Example | Example |
| | Example 3 | Example 4 | 2 | 3 |
| E-SBR | 82.5 (60) | 82.5 (60) | 82.5 (60) | 82.5 (60) |
| S-SBR | — | — | — | — |
| BR | 20 | 20 | 20 | 20 |
| NR | 20 | 20 | 20 | 20 |
| Carbon black (1) | 5 | 5 | 5 | 5 |
| Carbon black (2) | — | — | — | — |
| Silica | 100 | 100 | 100 | 100 |
| Silane coupling agent | 10 | 10 | 10 | 10 |
| Oil | 2 | 2 | — | — |
| Zinc oxide | 2 | — | — | — |
| Stearic acid | 2 | — | — | — |
| Fatty acid metal | — | — | 6 | 15 |
| salt (1) | | | | |
| Fatty acid metal | — | — | — | — |
| salt (2) | | | | |
| Antiaging agent | 2 | 2 | 2 | 2 |
| Sulfur | 2 | 2 | 2 | 2 |
| Vulcanization | 1.5 | 1.5 | 1.5 | 1.5 |
| accelerator (1) | | | | |
| Vulcanization | 0.5 | 0.5 | 0.5 | 0.5 |
| accelerator (2) | | | | |
| Compound (1) | — | 1 | 1 | 0.75 |
| represented | | | | |
| by Formula (1) | | | | |
| Compound (2) | — | — | — | — |
| represented | | | | |
| by Formula (1) | | | | |
| Vulcanized | 100 | 93 | 101 | 103 |
| rubber hardness | | | | |
| (23° C.) (INDEX) | | | | |
| Vulcanized rubber tear | 100 | 83 | 98 | 97 |
| strength (INDEX) | | | | |
| Vulcanized rubber | 100 | 19 | 100 | 103 |
| fatigue | | | | |
| resistance (INDEX) | | | | |
| | | | | Com- |
| | Example | Example | Example | parative |
| | 4 | 5 | 6 | Example 5 |
| E-SBR | 82.5 (60) | 82.5 (60) | 82.5 (60) | 82.5 (60) |
| S-SBR | — | — | — | — |
| BR | 20 | 20 | 20 | 20 |
| NR | 20 | 20 | 20 | 20 |
| Carbon black (1) | 5 | 5 | 5 | 5 |
| Carbon black (2) | — | — | — | — |
| Silica | 100 | 100 | 100 | 100 |
| Silane coupling agent | 10 | 10 | 10 | 10 |
| Oil | — | — | — | — |
| Zinc oxide | — | — | — | — |
| Stearic acid | — | — | — | — |
| Fatty acid metal | — | 15 | 15 | 31 |
| salt (1) | | | | |
| Fatty acid metal | 11 | — | — | — |
| salt (2) | | | | |
| Antiaging agent | 2 | 2 | 2 | 2 |
| Sulfur | 2 | 2 | 2.2 | 2 |
| Vulcanization | 1.5 | 1.5 | 1.5 | 1.5 |
| accelerator (1) | | | | |
| Vulcanization | 0.5 | 0.5 | 0.5 | 0.5 |
| accelerator (2) | | | | |
| Compound (1) | 0.75 | — | 0.55 | 0.5 |
| represented | | | | |
| by Formula (1) | | | | |
| Compound (2) | — | 1.5 | — | — |
| represented | | | | |
| by Formula (1) | | | | |
| Vulcanized | 100 | 100 | 101 | 101 |
| rubber hardness | | | | |
| (23° C.) (INDEX) | | | | |
| Vulcanized rubber | 97 | 98 | 97 | 85 |
| tear strength (INDEX) | | | | |
| Vulcanized rubber | 102 | 103 | 104 | 104 |
| fatigue | | | | |
| resistance (INDEX) | | | | |

As can be seen from the results shown in Table 3, the vulcanized rubbers of the rubber compositions of Examples 1 to 6 can maintain and improve the rubber properties while maintaining the rubber hardness without using zinc oxide. On the other hand, in the case of Comparative Example 4 obtained by adding only the compound represented by Formula (1) without adding the fatty acid metal salt, the rubber properties deteriorated. Further, in the case of Comparative Example 5 containing the fatty acid metal salt in an excessive amount, the vulcanized rubber tended to deteriorate in tear strength.

TABLE 4

| | Comparative | |
|---|---|---|
| | Example 6 | Example 7 |
| E-SBR | — | — |
| S-SBR | — | — |
| BR | — | — |
| NR | 100 | 100 |
| Carbon black (1) | — | — |
| Carbon black (2) | 40 | 40 |
| Silica | — | — |
| Silane coupling agent | — | — |
| Oil | — | — |
| Zinc oxide | 3 | — |
| Stearic acid | 3 | — |
| Fatty acid metal salt (1) | — | 23 |
| Fatty acid metal salt (2) | — | — |
| Antiaging agent | 2 | |
| Sulfur | 2 | 2 |
| Vulcanization accelerator (1) | 1.5 | 1.5 |
| Vulcanization accelerator (2) | — | — |
| Compound (1) represented by | — | 1.2 |
| Formula (1) | | |
| Compound (2) represented by | — | — |
| Formula (1) | | |
| Vulcanized rubber hardness | 103 | 103 |
| (23° C.) (INDEX) | | |
| Vulcanized rubber tear strength | 100 | 99 |
| (INDEX) | | |
| Vulcanized rubber fatigue | 100 | 100 |
| resistance (INDEX) | | |

As can be seen from the results shown in Table 4, even in the case of the rubber composition of Example 7 obtained by adding only natural rubber, the vulcanized rubber thereof can maintain and improve the rubber properties while maintaining the rubber hardness.

What is claimed is:

1. A rubber composition for pneumatic tires, containing a diene-based rubber, a fatty acid metal salt, and a compound represented by following Formula (1):
[Formula 1]
R—S—(CH₂)ₓ—S—R (1)
(wherein x is an integer of 2 to 12 and R contains a sulfur atom and contains a thiocarbamoyl group having an aromatic hydrocarbon or an aliphatic hydrocarbon, a benzothiazole group having an aromatic hydrocarbon or an aliphatic hydrocarbon, or a —SO₃⁻Na⁺ group), wherein
when a total amount of a diene-based rubber is taken as 100 parts by mass, the fatty acid metal salt is contained in an amount of 3 to 30 parts by mass and the compound represented by Formula (1) is contained in an amount of 0.15 to 1.5 parts by mass, and
when a total amount of a diene-based rubber is taken as 100 parts by mass, a content of a metal oxide is less than 0.5 parts by mass.

2. The rubber composition for pneumatic tires according to claim 1, wherein the fatty acid metal salt is at least one selected from the group consisting of zinc stearate and zinc laurate.

3. The rubber composition for pneumatic tires according to claim 1, wherein the fatty acid metal salt is zinc stearate.

4. The rubber composition for pneumatic tires according to claim 1, wherein the compound represented by Formula (1) is at least one selected from the group consisting of 1,6-bis(N,N′-dibenzylthiocarbamoyldithio)hexane and 1,6-hexamethylene-sodium dithiosulfate dihydrate.

5. The rubber composition for pneumatic tires according to claim 1, wherein the compound represented by Formula (1) is 1,6-bis(N,N′-dibenzylthiocarbamoyldithio)hexane.

6. The rubber composition for pneumatic tires according to claim 1, wherein
the fatty acid metal salt is at least one selected from the group consisting of zinc stearate and zinc laurate, and
the compound represented by Formula (1) is at least one selected from the group consisting of 1,6-bis(N,N′-dibenzylthiocarbamoyldithio)hexane and 1,6-hexamethylene-sodium dithiosulfate dihydrate.

7. The rubber composition for pneumatic tires according to claim 1, wherein
the fatty acid metal salt is zinc stearate and
the compound represented by Formula (1) is 1,6-bis(N,N′-dibenzylthiocarbamoyldithio)hexane.

8. The rubber composition for pneumatic tires according to claim 1, which further contains 1 to 3 parts by mass of sulfur in terms of sulfur content.

9. The rubber composition for pneumatic tires according to claim 6, which further contains 1 to 3 parts by mass of sulfur in terms of sulfur content.

10. The rubber composition for pneumatic tires according to claim 7, which further contains 1 to 3 parts by mass of sulfur in terms of sulfur content.

11. A pneumatic tire comprising at least a vulcanized rubber of the rubber composition for pneumatic tires according to claim 1.

12. A pneumatic tire comprising at least a vulcanized rubber of the rubber composition for pneumatic tires according to claim 6.

13. A pneumatic tire comprising at least a vulcanized rubber of the rubber composition for pneumatic tires according to claim 7.

14. A pneumatic tire comprising at least a vulcanized rubber of the rubber composition for pneumatic tires according to claim 8.

15. A pneumatic tire comprising at least a vulcanized rubber of the rubber composition for pneumatic tires according to claim 9.

16. A pneumatic tire comprising at least a vulcanized rubber of the rubber composition for pneumatic tires according to claim 10.
